(19) United States
(12) Patent Application Publication
(10) Pub. No.: US 2011/0227712 A1
(43) Pub. Date: Sep. 22, 2011

(54) COMPUTERIZED MULTIPLE TECHNOLOGY BASED VEHICLE ALARM SYSTEM AND METHOD

(76) Inventor: Marvin R. ATTECK, Clinton, MD (US)

(21) Appl. No.: 12/726,543

(22) Filed: Mar. 18, 2010

(51) Int. Cl. B60R 25/10; H04N 7/18; H04M 11/04

(52) U.S. Cl. 340/429; 348/148; 455/404.2; 348/E07.09

(57) ABSTRACT

The present invention is a computerized multiple technology vehicle alarm system that includes a closed circuit surveillance camera system, a plurality of door sensors, a plurality of microwave motion sensors, a plurality of shock sensors, a plurality of glass breakage sensors, a GPS system, an engine disabling device, a plurality of visual and audible alarms, a localized computer system and a centralized remote computer system to receive, process and store overall system data. There is also a computer software method for processing vehicle entry of a vehicle and for processing a vehicle break-in of a vehicle used in combination with the computerized multiple technology vehicle alarm system.

### BACKGROUND OF THE INVENTION

1. Field of the Invention

The present invention generally relates to a computerized multiple technology based vehicle alarm system. More specifically, the invention is a computerized multiple technology based vehicle alarm system that utilizes closed circuit surveillance technology, a variety of sensors and alarms and global positioning satellite technology, with a localized and remote storage of audio, video and other relevant data, that can be accessed and also limitedly controlled by a cell phone, a land-line phone, a personal digital assistant or a computer.

2. Description of Related Art

Protecting a vehicle is more important than ever in today's modern crime ridden society. Nothing is more helpless for the owner of a vehicle to have his or her vehicle stolen or broken into with the result of losing their valuable property. Criminals unfortunately, have become more sophisticated and brazen in their approach to stealing vehicles. Fortunately, vehicle protection has gotten more sophisticated and much improved over the last few decades with the existence of various sensors such as door sensors, motion sensors, shock sensors, glass breakage sensors and various technologies such as global positioning satellite (GPS) technology, as well as engine disabling device technologies. Technology in general has improved as well with closed circuit cameras, computers and improved software, the Internet, cellular phones and various other cellular devices.

### SUMMARY OF THE INVENTION

The present invention is directed to a computerized multiple technology vehicle alarm system that includes a closed circuit surveillance camera system, a plurality of door sensors, a plurality of microwave motion sensors, a plurality of shock sensors, a plurality of glass breakage sensors, a GPS system, an engine disabling device, a plurality of visual and audible alarms, a localized computer system and a centralized remote computer system to receive, process and store overall system data. There is also a computer software method for processing vehicle entry of a vehicle and for processing a vehicle break-in of a vehicle used in combination with the computerized multiple technology vehicle alarm system.

There are several advantages to the present invention. The invention provides a computerized multiple technology based vehicle alarm system that utilizes a wide variety of the latest current technologies and sensors integrated into a single computerized system. The invention also provides a computerized multiple technology based vehicle alarm system that can access video, audio and other relevant data from a user's computer, cell phone, land-line phone or other cellular device.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a system overview of the computerized multiple technology based vehicle alarm system.

FIG. 2 illustrates a system overview of the closed circuit surveillance component of the computerized multiple technology based vehicle alarm system.

FIG. 3 illustrates a door sensor, a microwave motion and shock sensor and a glass breakage sensor component of the computerized multiple technology based vehicle alarm system.

FIG. 4 illustrates a global positioning satellite tracking component of the computerized multiple technology based vehicle alarm system.

FIG. 5 illustrates a diagram showing a cell phone, cellular device, landline and computer capability to limitedly control the computerized multiple technology based vehicle alarm system.

FIG. 6 illustrates a diagram showing how overall system data is transmitted from a localized computer system to a centralized remote computer system and to a cell phone, computer, landline or cellular device according to the computerized multiple technology based vehicle alarm system.

FIG. 7A illustrates the software steps performed for vehicle entry into a vehicle protected by the computerized multiple technology based vehicle alarm system.

FIG. 7B illustrates the software steps performed for processing a vehicle break-in performed by the computerized multiple technology based vehicle alarm system.

### DETAILED DESCRIPTION OF THE INVENTION

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

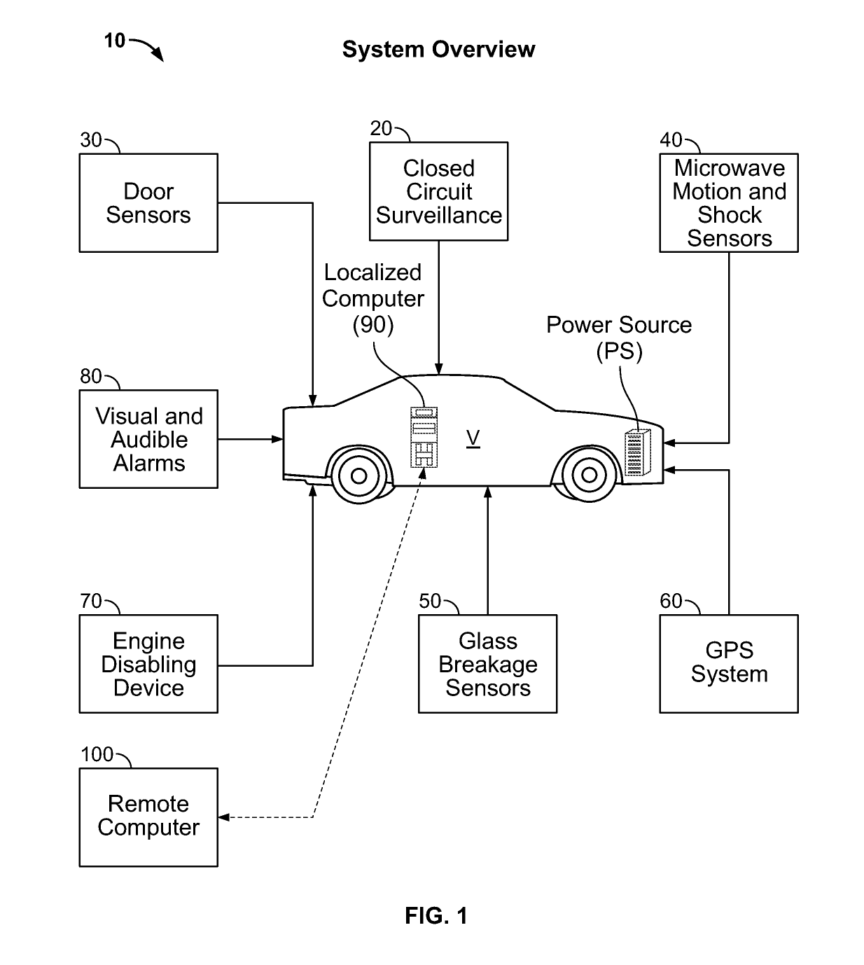

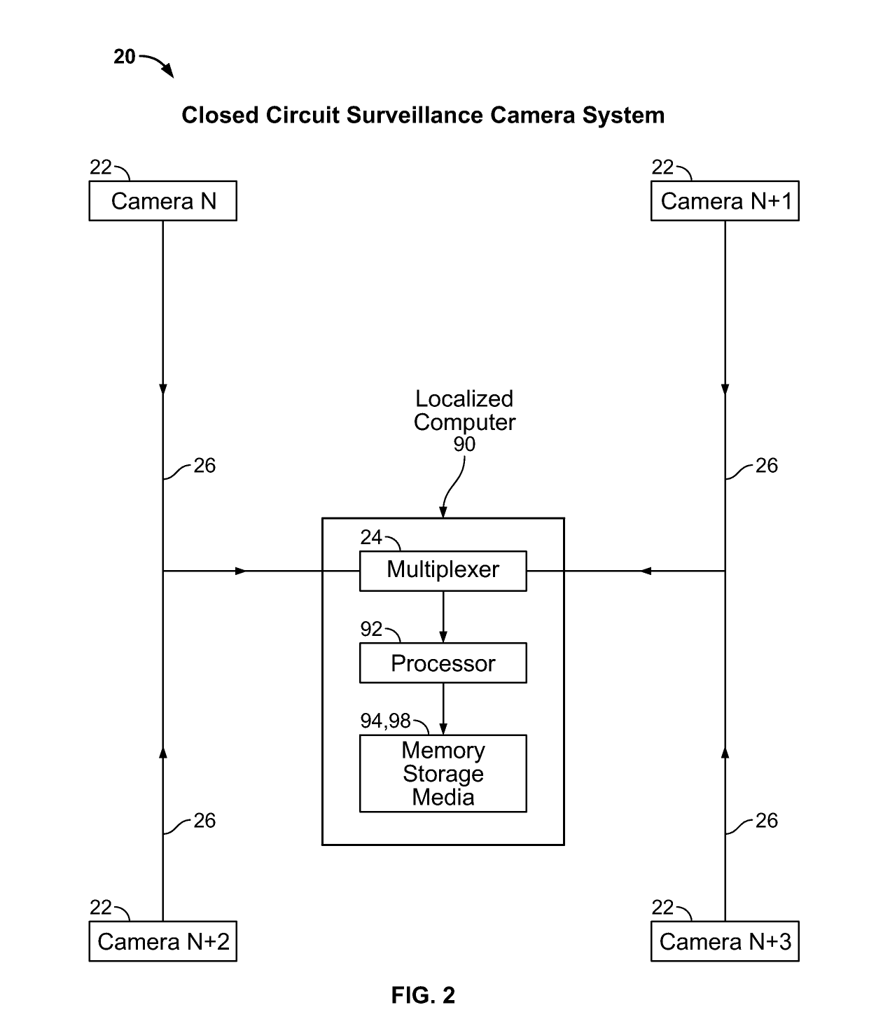

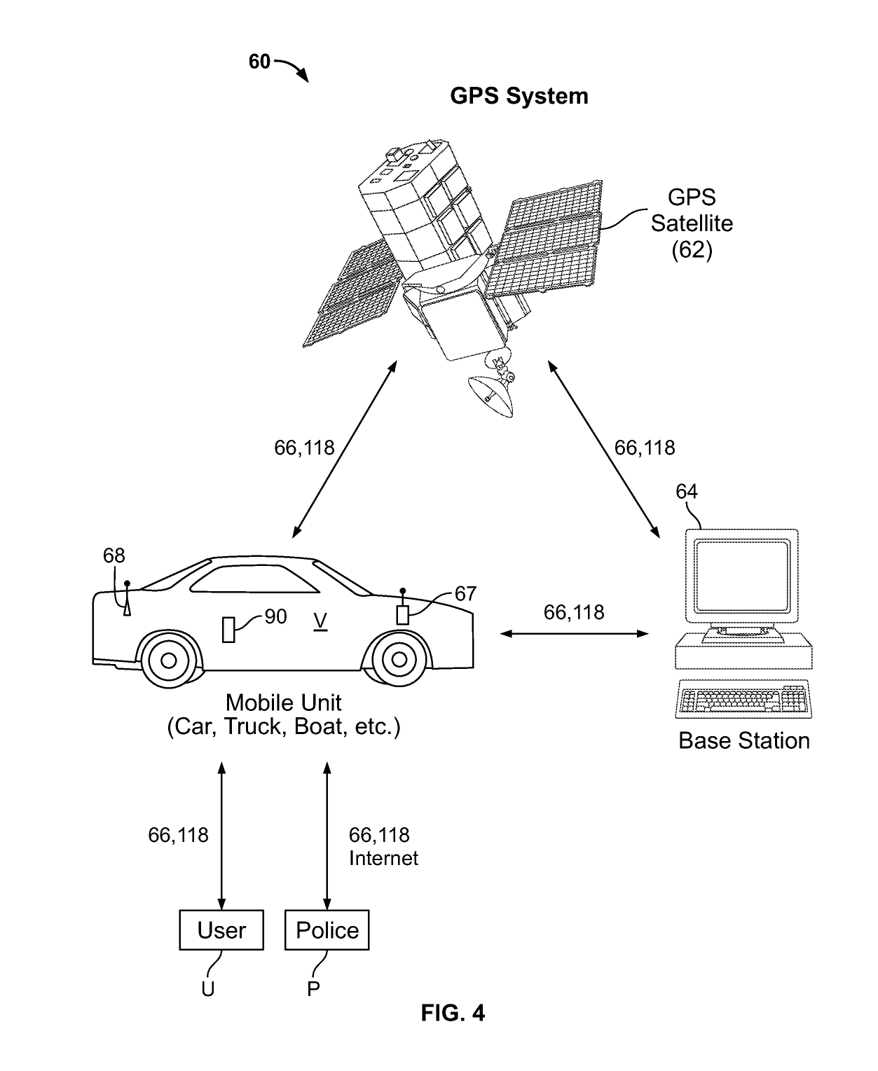

FIG. 1 illustrates a system overview of the computerized multiple technology based vehicle alarm system 10. The computerized multiple technology vehicle alarm system 10 is incorporated into a vehicle V with a power source PS, a plurality of exterior and interior lights and a plurality of doors (not shown) for protecting the vehicle V. The vehicle alarm system 10 includes a closed circuit surveillance camera system 20 with a plurality of closed circuit cameras 22 and a multiplexer 24 to visually monitor and protect the vehicle V (as further discussed in the FIG. 2 discussion), a plurality of door sensors 30 to sense when the plurality of doors of the vehicle V are being unauthorizably opened and closed, a plurality of microwave motion sensors and shock sensors 40 to protect the vehicle V, a plurality of glass breakage sensors 50 to detect when any protected glass (not shown) of the vehicle V is broken and a GPS system 60 with a plurality of GPS satellites 62 and a GPS base station 64 to produce tracking and descriptive data from the vehicle 66 (as is further discussed in the FIG. 4 discussion). The vehicle alarm system 10 also includes an engine disabling device 70 to shutoff the vehicle V when the vehicle alarm system 10 is activated, a plurality of visual and audible alarms 80 to protect the vehicle V, a localized computer system 90 with a processor 92, such as a central processing unit CPU for processing overall system data 96 and a memory 94, such as a hard drive, for storing the overall system data 96 on a storage medium 98 (as is further discussed in the FIG. 2 description) to coordinate and store the overall system data 96 involving the surveillance camera system 20, the motion and shock sensors 40, the GPS system 60, the glass breakage sensors 50, the engine disabling device 70, the visual and audible alarms 80, the door sensors 30 and a centralized remote computer system 100 to receive and store the overall system data 96 from the localized computer system 90. Also, for the purposes of the vehicle alarm system 10, a vehicle (V) is also defined as a car, a truck or a van.

FIG. 2 illustrates a system overview of the closed circuit surveillance camera system 20 utilized with the computerized multiple technology based vehicle alarm system 10. The closed circuit surveillance camera system 20 utilizes a plurality of closed circuit cameras 22 that can be disposed inside and outside of the vehicle V. The plurality of closed circuit cameras 22 transmit first video data 26 when activated, to a multiplexer 24 and a 92 processor, where first video data 26 is then recorded on a storage medium 98 of the localized computer system 90 and is then transmitted to and stored in the centralized remote computer system 100.

The plurality of cameras 22 can be set-up a variety of ways, both in and or outside of the vehicle V and generate first video data 26 that captures all of the footage from each camera from a video cassette recorder VCR or digital video recorded DVR to record the footage onto a DVD disc or VCR cassette (not shown).

The multiplexer 24 handles several video signals from the plurality of cameras 22 simultaneously for programmable event monitoring, display, and recording. The multiplexer 24 can split a monitor into various display areas, showing the input from the plurality of cameras 22 at the same time. The multiplexer 24 comes in a variety of configurations, including a monochromatic or color display, with a variety of features, including high resolution or real time refresh rates, low power consumption and low profile designs. The multiplexer 24 is also known as a mux and can record the first video data 26 coming in from the plurality of cameras 22 and may provide simultaneous display and playback features, allowing for the careful monitoring of secure areas.

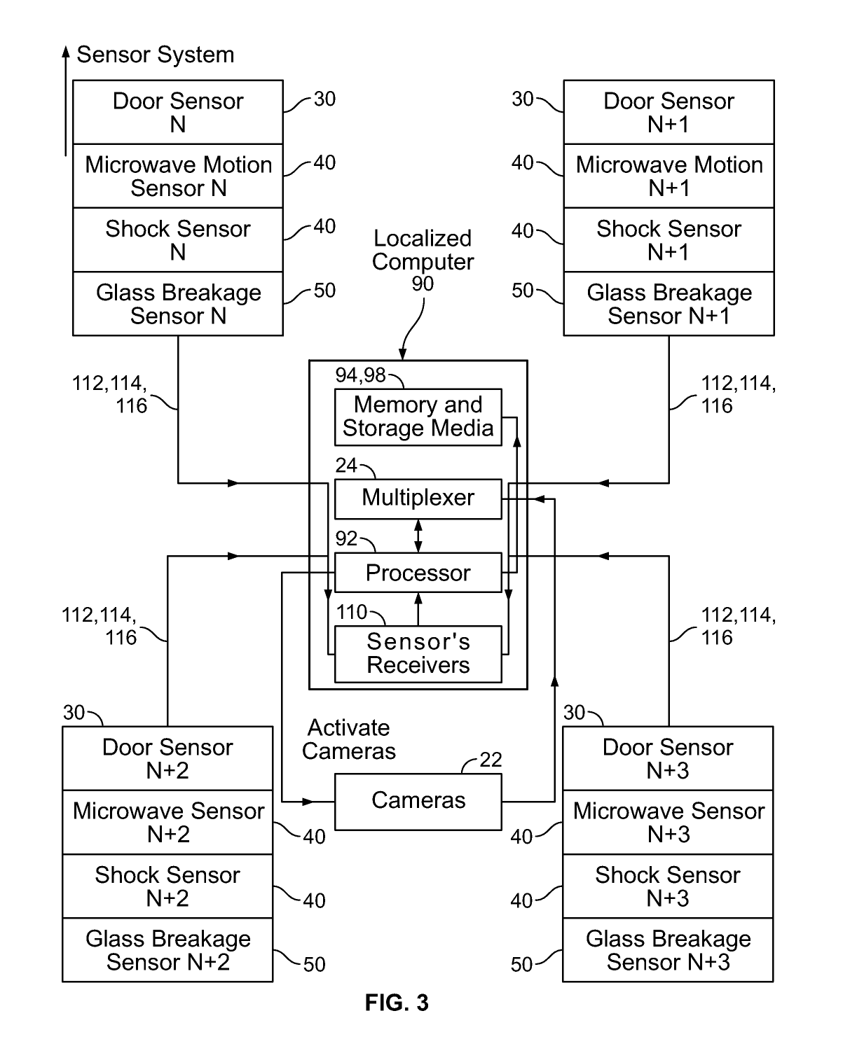

FIG. 3 illustrates a plurality of door sensors 30, a plurality of microwave motion and shock sensors 40 and a plurality of glass breakage sensors 50 utilized with the computerized multiple technology based vehicle alarm system 10. The plurality of door sensors 30 transmits a signal to the sensor receivers 110 and the processor 92 when activated. The processor 92 activates the surveillance cameras 22, which then transmit second video data 112 to the multiplexer 24, where second video data 112 is then stored on the storage media 98 of the localized computer system 90 and is then transmitted to and stored on the centralized remote computer system 100. The processor 92 then activates the visual and audible alarms 80.

The plurality of motion and shock sensors 40 operate with the vehicle alarm system 10 in a very similar way that the door sensors 30 operate. The motion and shock sensors 40 transmit a signal to the sensor receivers 110 and the processor 92 when activated. The processor 92 then activates the surveillance cameras 22, which then transmit third video data 114 to the multiplexer 24, where the third video data 114 is then stored on the storage media 98 of the localized computer system 90 and is then transmitted to and stored on the centralized remote computer system 100. The processor 92 then activates the visual and audible alarms 80.

The microwave motion detectors 40 emit high-frequency radio waves that are reflected by objects in their path. They can sense any change in the pattern of these waves. The movement of an intruder in or near the vehicle V will disturb the pattern and the motion detectors 40 will activate. Because the microwave motion detector 40 is highly sensitive, it can be prone to false alarms. For that reason, it is often combined with another type of alarm sensor.

The idea of a shock sensor 40 is also simple. If somebody hits, jostles or otherwise moves the vehicle V, the shock sensor 40 sends a signal to the brain of the shock sensor system (not shown) indicating the intensity of the motion. Depending on the severity of the shock, the shock sensor 40 activates the plurality of visual and audible alarms 80. There are many different ways to construct a shock sensor 40. One simple shock sensor 40 is a long, flexible metal contact positioned just above another metal contact. You can easily configure these contacts as a simple switch. When you touch them together, current flows between them. A substantial jolt will cause the flexible contact to sway so that it touches the contact below, completing the circuit briefly.

Like the door sensors 30 and the microwave and shock sensors 40, the plurality of glass breakage sensors 50 transmit a signal to the sensor receivers 110 and the processor 92 when activated. The processor 92 then activates the surveillance cameras 22, which then transmit fourth video data 116 to the multiplexer 24, where the fourth video data 116 is then stored on the storage media 98 of the localized computer system 90 and is then transmitted to and stored on the centralized remote computer system 100. The processor 92 then activates the visual and audible alarms 80. The glass-breaking sensors 50 are very sensitive to certain sound frequencies, particularly to glass breaking and wood splintering frequencies. The glass breaking sensors 50 can detect the vibrations generated by breaking glass or can be triggered by sound waves. The glass breaking sensors 50 can be mounted directly on the glass of the vehicle V or be installed to detect sound waves within approximately 30 to 40 feet in all directions. The glass breakage sensors 50 cannot detect triggers through walls or around corners and are activated as soon as the glass breakage sensors 50 detect the shattering glass. They protect a wider area than the shock sensors 40, but also can be triggered by noises that they mistake for breaking glass. The glass-breaking sensors 50 are designed to detect a break-in before an intruder has time to get inside the vehicle V.

FIG. 4 illustrates a global positioning satellite system (GPS) 60 utilized with the computerized multiple technology based vehicle alarm system 10, which was also discussed in the FIG. 1 discussion. The global positioning system 60 electronically transmits travel and descriptive data 66 to the localized computer system 90 where the travel and descriptive data 66 is then saved on the storage medium 98. The localized computer system 90 electronically transmits the travel and descriptive data 96 of the vehicle V to the user U and a local police department P via cellular tower technology and the Internet. The cellular tower technology is well known to those schooled in the art and also utilizes a wireless adaptor 68 placed in the vehicle V as part of the data transmission to the user U. The police department P is also contacted via a wireless or DSL Internet connection, which is also well known to those schooled in the art. The travel and descriptive data 96 includes tracked and logged vehicle location at all times, fifth video data, audio data, still images and a detailed description of what happened to the vehicle V.

The global positioning system is a network of satellites 62 and base stations 64 designed primarily for tracking, navigating and surveillance of the vehicle V. A transmitter 67 is hidden in the body of the vehicle V and runs off a battery or a separate battery pack placed under the hood (not shown). The transmitter 67 is not turned on until it is needed. Software is also used to plot the vehicle's V location on a map that is not described in this application. The GPS system 60 gets its signals from the satellites 62 to provide the user U to find his or her navigational way, but it also pinpoints the vehicle's V location. The GPS system 60 is used in vehicles V for both tracking and navigation. The tracking system aspect enables a base station 62 to keep track of the vehicles V without the intervention of the user U where, as the navigation system aspect helps the user U to reach a desired destination. Whether navigation system or tracking system aspects are used, the architecture is the same as depicted in FIG. 4.

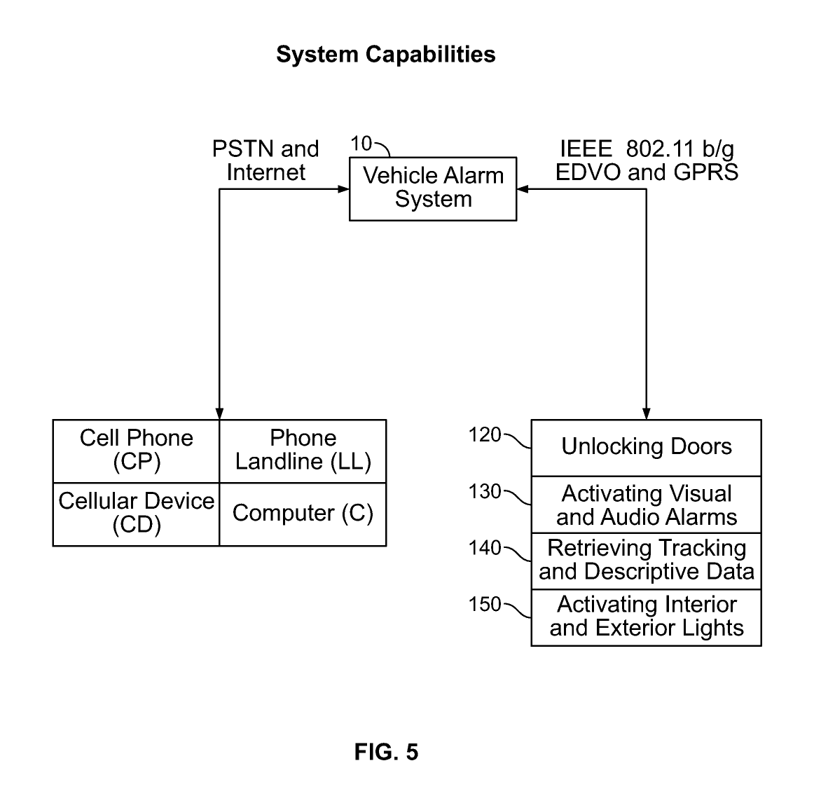

FIG. 5 illustrates a diagram showing a cell phone CP, a cellular device CD, a landline LL and a computer C capability to limitedly control the computerized multiple technology based vehicle alarm system 10. The user U can use the vehicle alarm system 10 to lock and unlocking doors 120, activate the visual and audio alarms 130, retrieve the tracking and descriptive data 140 and activate interior and exterior lights 150 using a cell phone CP, a landline phone LL, a cellular device CD or an outside computer C. The vehicle alarm system 10 utilizes public switched telephone network (PSTN) technology, evolution data only technology (EDVO), general packet radio service (GPRS) technology and IEEE 802.11b/g technology to lock and unlocking the doors 120, activate the visual and audio alarms 130, activate the exterior and interior lights 150 and retrieve the tracking and descriptive data 140 using a cell phone CP, a landline phone LL, a cellular device CD or an outside computer C. PSTN technology, EDVO technology, GPRS technology and IEEE 802.11b/g technology are all well known to those schooled in the art.

The 802.11 family includes over-the-air modulation techniques that use the same basic protocol. The most popular are those defined by the 802.11b and 802.11g wireless protocols, and are amendments to the original standard. 802.11-1997 was the first wireless networking standard, but 802.11b was the first widely accepted one, followed by 802.11g and 802.11n.

EVDO works similarly to the way a cell phone operates in that it relies on a signal from a wireless tower rather than a physical connection like a phone line or cable. An EVDO modem or aircard, receives the signal and allows a user to connect to the Internet. EVDO modems come in several formats such as USB dongle, an express card and a PCMCIA card and they can be used either directly in a computer or in a 3G router.

The public switched telephone network (PSTN) is a network of the world's public circuit switched telephone networks, in much the same way that the Internet is the network of the world's public IP-based packet-switched networks. Originally a network of fixed-line analog telephone systems, the PSTN is now almost entirely digital and includes mobile as well as fixed telephones. The General Packet Radio Service (GPRS) network is an always on private network for data. It uses the existing GSM network to transmit and receive TCP/IP based data to and from GPRS mobile devices. Private IP addresses are typically dynamically assigned within the network to mobile devices. However, Access Point Names (APN's) provide a gateway route to other networks such as the Internet, WAP services or private corporate networks. Firewalls typically reside at the APN to isolate the public and private networks. IP addresses allocated to mobile GPRS devices are therefore not addressable from outside the GPRS network (e.g. from the Internet) without specialized services or infrastructure.

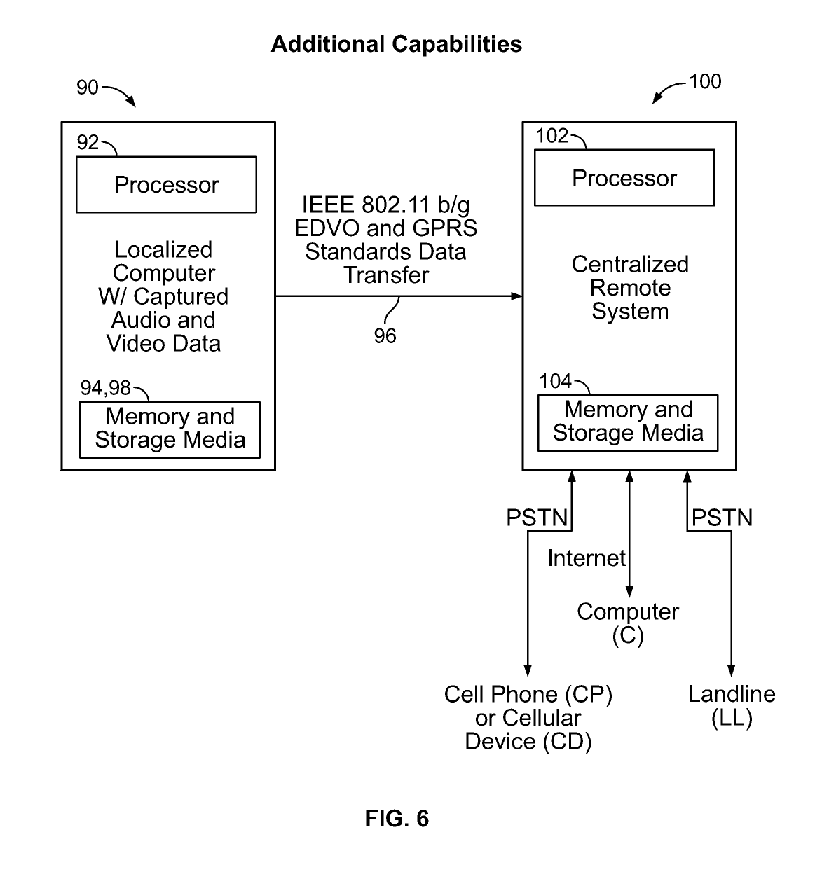

FIG. 6 illustrates a diagram showing how the overall system data 96 is transmitted from a localized computer system 90 to a centralized remote computer system 100 and to a cell phone CP, a computer C, a landline phone LL or a cellular device CD, according to the computerized multiple technology based vehicle alarm system 10. The localized computer system 90 transmits the overall system data 96 via evolution data only technology (EDVO), general packet radio service (GPRS) technology and the IEEE 802.11b/g standard to the centralized remote computer system 100. The overall system data 96 can be further transmitted to a cell phone CP, a cellular device CD, a computer C and a landline telephone LL. The overall system data 96 is transmitted to the cell phone CP, the cellular device CD and the landline telephone LL utilizing public switched telephone network (PSTN) technology. The overall system data 96 is transmitted to the computer C utilizing the Internet either through a wireless connection or DSL connection. All of these technologies were previously discussed in the FIG. 5 discussion and are all well known to those skilled in the art.

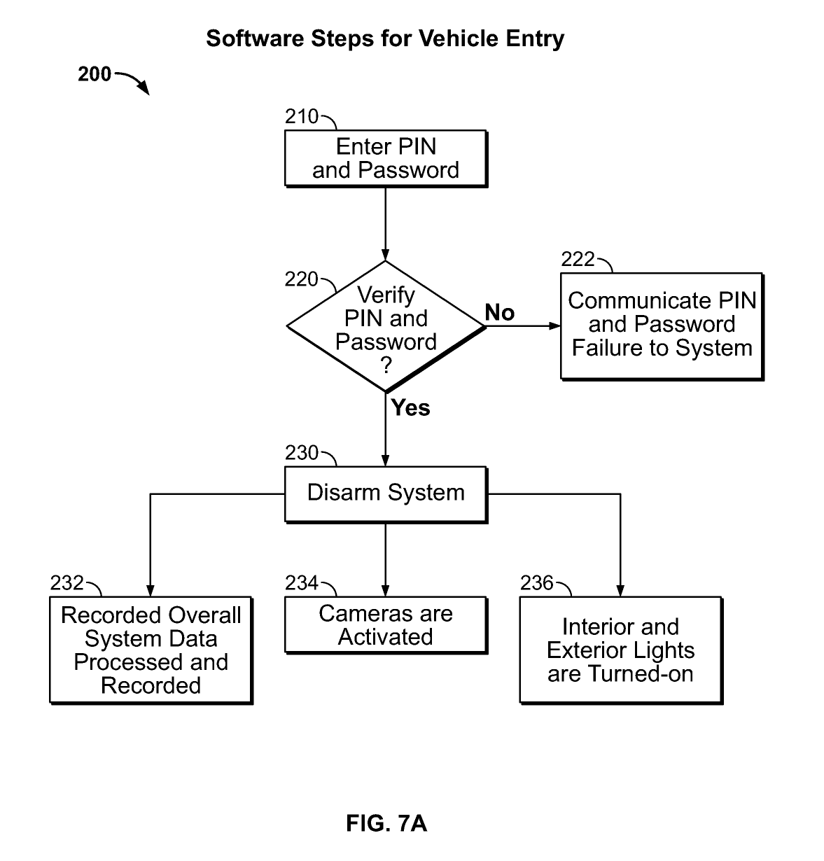

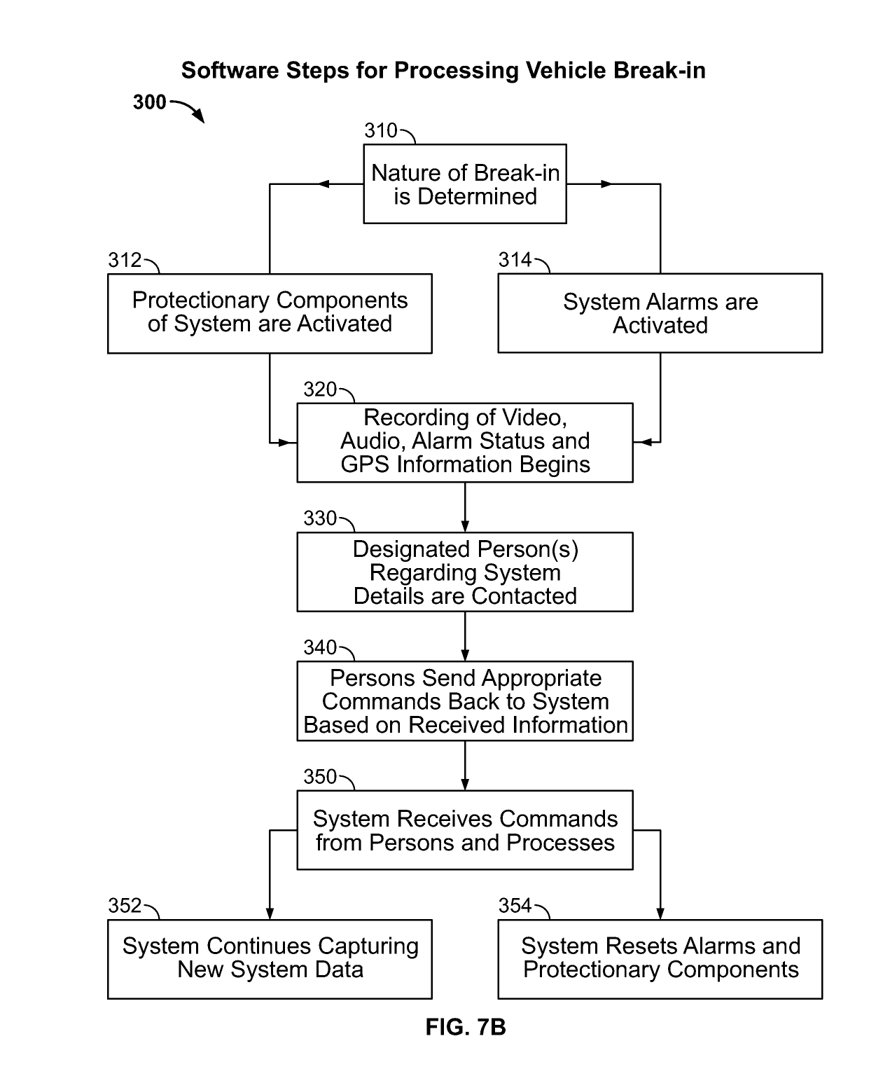

FIG. 7A illustrates a computer software method for processing vehicle entry of a vehicle 200 protected by the computerized multiple technology vehicle alarm system 10 with overall system data 96 that includes data from a closed circuit surveillance camera system 20, a plurality of microwave motion and shock sensors 40, a plurality of door sensors 30, a plurality of glass breakage sensors 50, a global positioning system (GPS) 60, an engine disabling device 70, a plurality of visual and audible alarms 80, a plurality of vehicle exterior and interior lights (not shown), a plurality of vehicle doors and locks (not shown) and tracking and descriptive data 66 from the GPS system 60. The vehicle entry software method 200 utilizes the processor 92 for processing the overall system data 96 from the localized computer system 90 and the memory 94 for storing the overall system data 96 on the storage medium 98 of the localized computer system 90 as well.

The first step of the vehicle entry software method 200 is for a user U to enter a personal identification number (PIN) and a password 210. This is done through the localized computer system 90. The second step of the vehicle entry software method 200 is to verify the personal identification number (PIN) and password 220. If the incorrect password or PIN is entered, the vehicle entry software method 200 will communicate PIN and password failure 222 to the localized computerized system 90. The third step of the vehicle entry software method 200 is to disarm the vehicle alarm system 230. Disarming the vehicle alarm system 10 includes the overall system data being recorded on the storage medium and then being provided and processed by the processor 232. Disarming the vehicle alarm system 10 also includes activating the surveillance camera system 234 and activating the interior and exterior lights of the vehicle 236.

FIG. 7B illustrates a computer software method for processing a vehicle break-in of a vehicle 300 protected by the computerized multiple technology vehicle alarm system 10 with overall system data 96 that includes data from protectionary components that include a closed circuit surveillance camera system 20, a plurality of microwave motion and shock sensors 40, a plurality of door sensors 30, a plurality of glass breakage sensors 50, a global positioning system (GPS) 60, an engine disabling device 70, a plurality of visual and audible alarms 80, a plurality of vehicle doors and locks (not shown), a plurality of vehicle exterior and interior lights (not shown) and tracking and descriptive data 66 from the GPS system 60. The method for processing a vehicle break-in of a vehicle 300 utilizes the processor 92 for processing the overall system data 96 from the localized computer system 90 and the memory 94 for storing the overall system data 96 on the storage medium 98 of the localized computer system 90 as well.

The first step of the method for processing a vehicle break-in of a vehicle 300 includes determining the nature of a vehicle break-in 310. Once a vehicle V protected by the vehicle protection system 10 is broken into, the protectionary components of the system are activated 312 and the visual and audible alarms of the system are activated 314, as depicted in FIGS. 1-4. The second step of the method for processing a vehicle break-in 300 includes the beginning of the recording of video, audio, alarm status and GPS information from the vehicle system 320, as is also depicted in FIGS. 1-4. Once that is done, the third step of the method 300 is then contacting designated persons regarding the system details 330, which is depicted in FIG. 4. The fourth step of the method 300 is then completed which involves the designated persons then sending any appropriate commands back to the system based on any received system information 340, as indicated in FIGS. 5 and 6. The fifth step would then be completed, which the system is receiving the commands from the designated persons and system processes 350, as is also indicated in FIGS. 5 and 6. The system would then either continue to capture new system data 352 or the system would reset its alarms and protectionary components 354 and resume protecting for another break-in.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A computerized multiple technology vehicle alarm system incorporated into a vehicle with a battery and an auxiliary battery back-up, a plurality of exterior and interior lights and a plurality of doors, for protecting said vehicle, comprising:
a localized computer system with a processor for processing overall system data and a memory for storing said overall system data on a storage medium, to coordinate and store said overall system data;
a closed circuit surveillance camera system with a plurality of closed circuit cameras disposed inside and outside of said vehicle to visually monitor said vehicle and a multiplexer in communication with said localized system and contributing to said overall system data;
a plurality of door sensors to sense when said plurality of doors of vehicle is being unauthorizably opened and closed in communication with said localized system and contributing to said overall system data;
a plurality of microwave motion sensors and a plurality of shock sensors to protect said vehicle in communication with said localized system and contributing to said overall system data;
a glass breakage sensor to detect when any protected glass of said vehicle is broken in communication with said localized system and contributing to said overall system data;
a GPS system with a plurality of GPS satellites and a GPS base station to produce tracking and descriptive data of said vehicle in communication with said localized system and contributing to said overall system data;
an engine disabling device to shutoff said vehicle when said vehicle alarm system is activated in communication with said localized system and contributing to said overall system data;
a plurality of visual and audible alarms to protect said vehicle in communication with said localized system and contributing to said overall system data; and
a centralized remote computer system to receive and store said overall system data from said localized computer system.

2. The system according to claim 1, wherein said surveillance cameras transmit first video data when activated to said multiplexer and said processor, where said first video data is then recorded on said storage medium of said localized computer system and then transmitted to and stored on said centralized remote computer system.

3. The system according to claim 1, wherein said door sensors transmit a signal to said sensor receivers and said processor activates said surveillance cameras and said visual and audible alarms, which then transmit second video data to said multiplexer, where said second video data is then stored on said storage medium of said localized computer system and then transmitted to and stored on said centralized remote computer system.

4. The system according to claim 1, wherein said motion and shock sensors transmit a signal to said sensor receivers and said processor activates said surveillance cameras and said visual and audible alarms, which then transmit third video data to said multiplexer, where said third video data is then stored on said storage medium of said localized computer system and then transmitted to and stored on said centralized remote computer system.

5. The system according to claim 1, wherein said glass breakage sensor transmits a signal to said sensor receivers and said processor activates said surveillance cameras and said visual and audible alarms, which then transmit fourth video data to said multiplexer, where said fourth video data is then stored on said storage medium of said localized computer system and then transmitted to and stored on said centralized remote computer system.

6. The system according to claim 1, wherein said global positioning system electronically transmits said travel and descriptive data to said localized computer system where said travel and descriptive data is then saved on said storage medium.

7. The system according to claim 6, wherein said localized computer system electronically transmits said travel and descriptive data of said vehicle to and from said user via cellular tower technology and a local police department via the Internet.

8. The system according to claim 7, wherein said travel and descriptive data includes tracked and logged said vehicle location at all times, fifth video data, audio data, still images and a detailed description of what happened to said vehicle.

9. The system according to claim 1, wherein said user can use said system to lock and unlock said doors, activate said visual and audio alarms, activate said exterior and interior lights and retrieve said tracking and descriptive data using a cell phone, a landline phone, a cellular device or an outside computer.

10. The system according to claim 9, wherein said system utilizes evolution data only technology (EDVO) and general packet radio service (GPRS) technology to lock and unlocking said doors, activate said visual and audio alarms, activate said exterior and interior lights and retrieve said tracking and descriptive data.

11. The system according to claim 1, wherein said localized computer system transmits said overall system data via evolution data only technology (EDVO) and general packet radio service (GPRS) technology to said centralized remote computer system.

12. The system according to claim 11, wherein said overall system data is transmitted to and from a cell phone, a cellular device and a landline telephone utilizing PSTN technology from said centralized remote computer system.

13. The system according to claim 11, wherein said overall system data is transmitted to and from an outside computer utilizing the Internet.

14. A computer software method for processing vehicle entry of a vehicle protected by a computerized multiple technology vehicle alarm system with overall system data that includes data from a closed circuit surveillance camera system, a plurality of microwave motion and shock sensors, a plurality of door sensors, a plurality of glass breakage sensors, a global positioning system (GPS), an engine disabling device, a plurality of visual and audible alarms, a plurality of vehicle exterior and interior lights, a plurality of vehicle doors and locks and tracking and descriptive data from said GPS system, a computer processor for processing said overall system data and a memory for storing said overall system data on a storage medium, comprising:
entering a personal identification number (PIN) and a password;
verifying said PIN and said password; and
disarming said computerized alarm system, activating said surveillance camera system and activating said interior and exterior lights.

15. The method according to claim 14, wherein entering a PIN and a password includes communicating PIN and password failure to said computerized system.

16. The method according to claim 14, wherein verifying said PIN and said password includes recording said overall system data on said storage medium that is provided and processed by said processor.

17. A computer software method for processing a vehicle break-in of a vehicle protected by a computerized multiple technology vehicle alarm system with overall system data that includes data from protectionary components that include a closed circuit surveillance camera system, a plurality of microwave motion and shock sensors, a plurality of door sensors, a plurality of glass breakage sensors, a global positioning system (GPS), an engine disabling device, a plurality of visual and audible alarms, a plurality of vehicle doors and locks, a plurality of vehicle exterior and interior lights and tracking and descriptive data from said GPS system, a computer processor for processing said overall system data and a memory for storing said overall system data on a storage medium, comprising:
determining a nature of said vehicle break-in;
recording video, audio, alarm status and said GPS system data;
contacting designated persons regarding said computerized system details;
sending appropriate commands from said designated persons regarding said recorded data; and
receiving said appropriate commands.

18. The method according to claim 17, wherein determining the nature of said vehicle break-in includes activating said protectionary components and said visual and audible alarms of said computerized system.

19. The method according to claim 17, wherein receiving said appropriate commands includes said computerized system continuing to capture new said overall system data after receiving said appropriate commands.

20. The method according to claim 17, wherein receiving said appropriate commands includes resetting said protectionary components and said visual and audible alarms of said computerized system.
